(19) United States
(12) Patent Application Publication
(10) Pub. No.: US 2024/0409296 A1
(43) Pub. Date: Dec. 12, 2024

(54) PACKAGING FOR LIGHT-ABSORBING PHARMACEUTICALS

(71) Applicant: Curadel Surgical Innovations, Inc., Natick, MA (US)

(72) Inventor: John V. Frangioni, Weston, MA (US)

(21) Appl. No.: 18/696,819

(22) PCT Filed: Sep. 23, 2022
(86) PCT No.: PCT/US2022/076901

§ 371 Date: Mar. 28, 2024

Related U.S. Application Data
(60) Provisional application No. 63/281,322, filed on Nov. 19, 2021.

(51) Int. Cl. B65D 81/30; A61J 1/14; A61J 1/16; B32B 15/12; B32B 15/20; B32B 27/10; B32B 27/36; B32B 29/06; B65D 5/56; B65D 5/62; B65D 65/38

(52) U.S. Cl. CPC B65D 81/30; A61J 1/1468; A61J 1/16; B32B 15/12; B32B 15/20; B32B 27/10; B32B 27/36; B32B 29/06; B65D 5/563; B65D 5/62; B65D 65/38; B32B 2255/06; B32B 2255/10; B32B 2307/4023; B32B 2307/416; B32B 2307/7376; B32B 2439/62; B32B 2439/80

(57) ABSTRACT

Secondary pharmaceutical packaging with multi-laminate materials of cardboard with one or more additional layers configured to block incident visible and/or near-infrared (NIR) light at an attenuation of log 4 optical density or more to provide improved photostability for optically active pharmaceuticals in vials held therein. The multi-laminate materials can include cardboard in a 10-26 point thickness range, and one of the following: (i) aluminum laminate and black or black matte ink; (ii) MET-PET and black ink or black matte ink; (iii) only aluminate laminate; and (iv) only MET-PET. The overall thickness of the packaging can be in a thickness range of 10-26 points. The secondary packaging can be configured as a pharmaceutical carton that can block over 99.99999% of incident visible and/or NIR light.

### RELATED APPLICATIONS

This patent application claims the benefit of and priority to U.S. Provisional Patent Application Ser. No. 63/281,322, filed Nov. 19, 2021, the contents of which are hereby incorporated by reference as if recited in full herein.

### FIELD OF THE INVENTION

This invention relates to secondary packaging for pharmaceuticals.

### BACKGROUND

Pharmaceuticals are often provided in primary packaging enclosed in secondary packaging. Primary packaging typically involves glass pharmaceutical vials manufactured under ISO 8362-1 and are available in a range of colors from clear to amber.

Most pharmaceuticals do not absorb visible or near-infrared (NIR) light and standard secondary packaging is conventionally made of solid bleached board (SBB) or solid bleached sulphate (SBS). SBS is a virgin fiber grade of paper board (often referred to as SBS cardboard). SBS is adequate for blocking UV light and quite suitable for secondary packaging of most pharmaceuticals. Therefore, little attention has been paid to visible and NIR wavelengths that are capable of penetrating SBS cardboard. Light-absorbing, optically active pharmaceuticals, including, but not limited to, NIR fluorescent contrast agents for image-guided surgeries, absorb energy in the spectral range of 400-650 (visible) and 650-850 nm (NIR) and are therefore susceptible to degradation when exposed to such wavelengths.

There is therefore a pressing need for improved secondary packaging of optically active pharmaceuticals.

### SUMMARY

Embodiments of the invention are directed to improved secondary packaging for light-absorbing, i.e., optically sensitive (e.g., NIR-light sensitive) pharmaceuticals.

Secondary pharmaceutical packaging with multi-laminate materials of SBS cardboard with one or more additional layers configured to block incident visible and/or near-infrared (NIR) light at an attenuation of log 4 optical density or more to provide improved photostability for optically active pharmaceuticals in vials held therein. The multi-laminate materials can include SBS cardboard in a thickness range of 10-26 points or more, and one of the following: (i) aluminum laminate and black ink and/or black matte ink; (ii) MET-PET and black ink and/or black matte ink; (iii) only aluminate laminate; and (iv) only MET-PET.

The secondary packaging can be configured as a pharmaceutical carton that can block 99.99% or more, e.g., 99.999% or move, or even 99.99999% or more, of incident visible and NIR light.

Embodiments of the present invention are directed to a pharmaceutical packaging material that includes a cardboard having opposing first and second primary surfaces, the first primary surface defining an external surface of the pharmaceutical packaging material. The cardboard has a thickness in a range of 10-26 points. The packaging material also includes a light scattering material attached to at least one of the first and second primary surface of the cardboard and a light absorbent material on the light scattering material and defining an inner and/or outer surface of the pharmaceutical packaging material.

The pharmaceutical packaging can be provided in combination with a vial enclosing a light-absorbing pharmaceutical held in the carton.

The cardboard can be a solid bleached sulphate (SBS) cardboard.

Yet other aspects of the present invention are directed to a pharmaceutical package that includes: a vial of glass enclosing an optically active pharmaceutical; and a carton holding the vial of glass. The carton includes a multi-laminate configuration with cardboard and one or more additional layers configured to block incident visible and/or near-infrared (NIR) light at an attenuation of log 4 optical density or more to thereby provide improved photostability for the optically active pharmaceutical in the vial relative to cardboard alone.

The light scattering material and the light absorbent material can have a cumulative thickness that is less than 10%, average, of the thickness of the cardboard.

The pharmaceutical packaging material can be configured to block incident visible and/or near-infrared (NIR) light at an attenuation of log 4 optical density or greater.

The light scattering material can include aluminum laminate directly laminated or directly bonded to the first and/or the second primary surface of the cardboard.

The light absorbent material can include black ink covering the light scattering material.

The light absorbent material can include and/or be provided by black matte ink covering the light scattering material.

The pharmaceutical packaging material can be provided as a carton.

The cardboard can be provided in a thickness range of 10-26 points. The one or more additional layers can be provided by one of the following: (i) aluminum laminate and black ink or black matte ink; (ii) MET-PET and black ink or black matte ink; (iii) only aluminate laminate; and (iv) only MET-PET.

The cardboard can be provided in a total thickness range of 10-26 points and can define a white external surface of the carton. The one or more additional layers can include aluminum laminate.

The cardboard can be solid bleached sulphate (SBS) cardboard.

The pharmaceutical package can include black ink covering the aluminum laminate that can define an inner and/or outer surface of the carton.

The pharmaceutical package can include black ink covering the aluminum laminate that can define an inner surface of the carton.

The pharmaceutical package can include black matte ink covering the aluminum laminate that can define an inner and/or outer surface of the carton.

The pharmaceutical package can include black matte ink covering the aluminum laminate that can define an inner surface of the carton.

The multi-laminate configuration of the carton is configured to block about 99.99% or more of incident visible and NIR light.

The multi-laminate configuration of the carton can be configured to block about 99.9999% or more of incident visible and NIR light.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Other systems and/or methods according to embodiments of the invention will be or become apparent to one with skill in the art upon review of the following drawings and detailed description. It is intended that all such additional systems, methods, and/or devices be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings.

FIG. 1A is a graph of transmission (percentage) versus wavelength (nm) for a 500 ml glass vial in three different colors, clear, protect and amber.

FIG. 1B is a graph of transmission (percentage) versus wavelength (nm) with curve C corresponding to clear (flint) glass, curve G corresponding to green glass, and curve A corresponding to amber (brown) glass with percent transmission representing “poor” protection and “good” protection at different wavelengths.

FIG. 2 is a graph of optical density (OD) versus wavelength (nm) in log scale showing light transmission and spectral filtering of various secondary packaging materials according to embodiments of the present invention.

FIG. 3 is a series of digital photographs showing, from left to right, a 2-log neutral density (ND 2) filter between a light source and camera (“light source only”), 14-pt virgin white SBS cardboard/paperboard, 14-pt SBS cardboard and MET-PET, 10-pt SBS cardboard and aluminum laminate, all images having a 50 ms exposure time and identical brightness, contrast and gamma settings, according to embodiments of the present invention.

FIG. 4 is a schematic illustration of a secondary packaging carton with an internal vial and leaflet and an exploded diagram of the multi-laminate structure of the packaging material according to embodiments of the present invention.

FIG. 5 is a top, open view of a secondary packaging carton, shown in a ready to fill configuration according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. One or more features shown and discussed with respect to one embodiment may be included in another embodiment even if not explicitly described or shown with another embodiment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

The term “about” means that the recited number or value can vary by +/−20%.

The term “optically active pharmaceutical” refers to light-absorbing and therefore light-sensitive pharmaceuticals and includes visible dyes, such as methylene blue, as well as NIR light sensitive pharmaceuticals such as fluorescent pharmaceuticals used for therapies and/or surgeries, e.g., indocyanine green. Examples also include, but are not limited to, pharmaceuticals comprising a visible color such as green or blue pharmaceuticals in dry powder, liquid, or tablet formulations.

The term “sterile” and derivatives thereof mean that the noted device or material meets or exceeds defined medical guidelines of sterility so as to be substantially (if not totally) free of contaminants for at least a defined shelf life so as to be suitable for intended medical uses for humans or animals.

The term “aseptic” is used interchangeably with the word “sterile”. In some embodiments, the aseptic processing or fabrication of vials and filling of the vials complies with GMP (Good Manufacturing Practice) industry guidelines such as those associated with Guidance for Industry—Sterile Drug Products Produced by Aseptic Processing—Current Good Manufacturing Practice, U.S. Department of Health and Human Services Food and Drug Administration, September 2004.

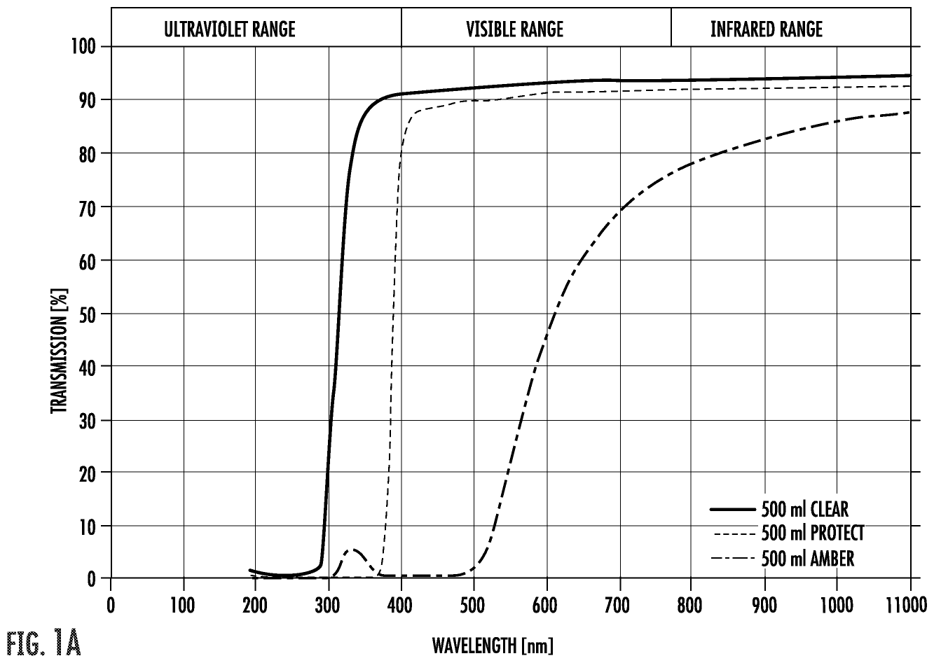

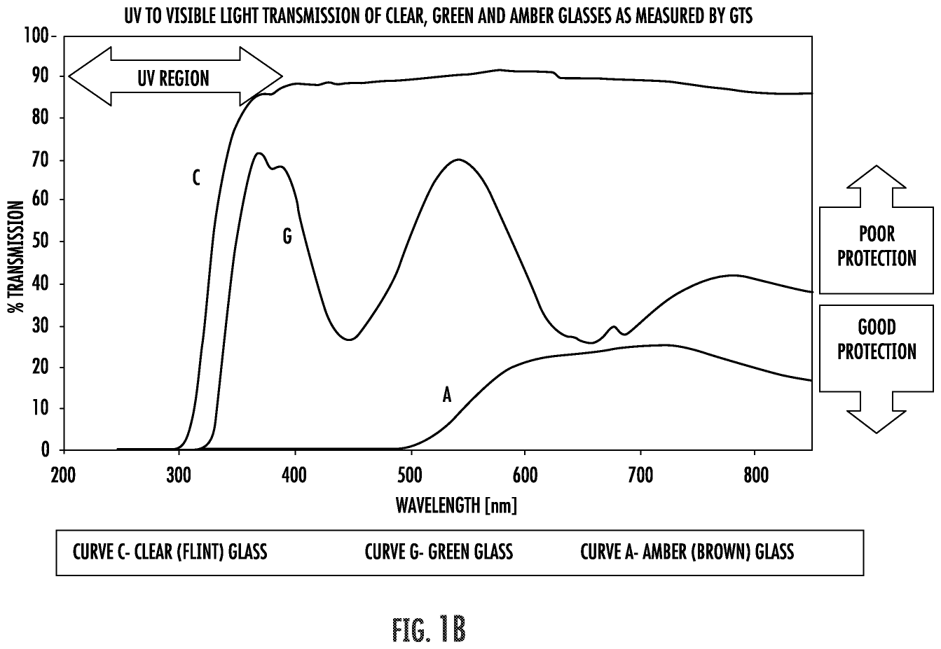

Pharmaceutical glass vials manufactured under ISO 8362-1 are available in a range of colors from clear to amber. Intuitively, darker colors, such as amber, would appear to be ideal for blocking NIR light. In truth, amber vials are rather poor at blocking NIR light. As shown in FIGS. 1A, 1B amber glass is extremely effective for blocking light below 500 nm, especially UV light. However, for NIR wavelengths, light transmission ranges from 25%-80% depending on the reference. See, Carl Roth GMBH, Duran, Wheaton, and Kimble Glassware Tables and General Information (FIG. 1A); and Glass wine bottles and UV light, WRAP Information Sheet, wrap.org.uk (FIG. 1B).

In addition to amber vials being ineffective for blocking NIR light, regulatory agencies often frown upon such vials because it is more difficult to see particulates during release testing. This is especially important in Japan, which is believed to have the strictest particulate specifications of any country. In summary, there is a tradeoff in primary packaging between blocking NIR light and being able to evaluate final drug product for particulates. Amber vials provide little benefit for the former and increase risk for the latter.

Accordingly, the present invention addresses a long-felt, unrecognized need developed using considerable time, effort, and resources in developing secondary packaging that provides maximal blocking of visible and NIR light, and thus protection of light-absorbing and optically sensitive pharmaceuticals.

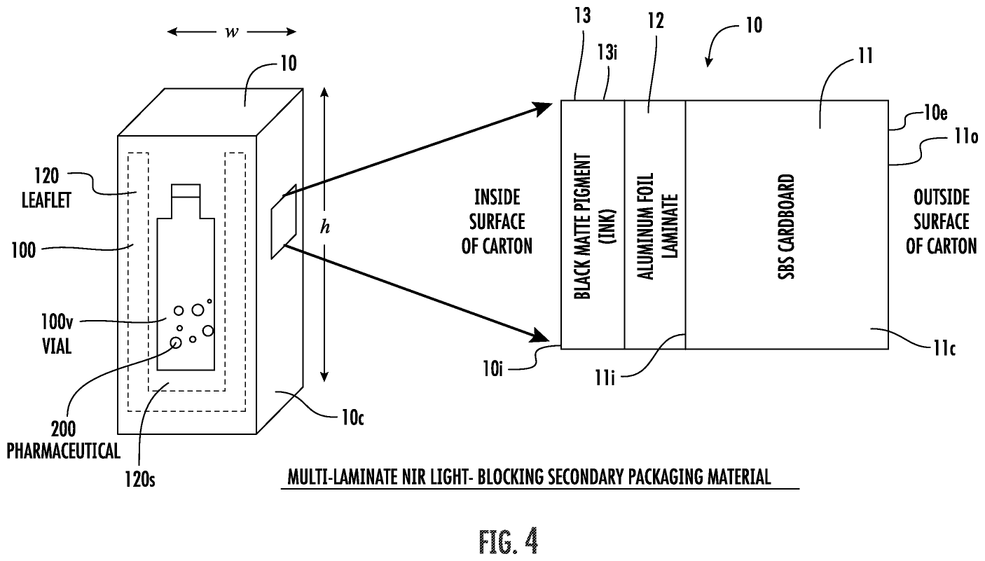

FIG. 4 illustrates an example primary packaging 100 enclosing a pharmaceutical 200 with the primary packaging held in secondary packaging 10. For the purposes of secondary packaging 10, light has only two possible fates: absorption and scatter. There are many different types of light scatter but the two with the most relevance to the secondary packaging of pharmaceuticals are multiple scattering events by opaque materials, and reflection from mirror-like surfaces.

The most common material for pharmaceutical packaging is virgin white solid bleached sulfate (SBS) cardboard in a thickness of 10-26 point (0.25-0.66 mm). Although relatively opaque to the human eye, SBS cardboard is not very effective in attenuating light, in particular NIR light. This is because the external white color and internal brown color absorb little light, and the thickness of the cardboard doesn't permit enough scattering events to prevent light from penetrating the carton. Interestingly, white SBS cardboard also fluoresces itself, and UV absorbed energy can be re-emitted into the package as broadband fluorescence peaking in the blue.

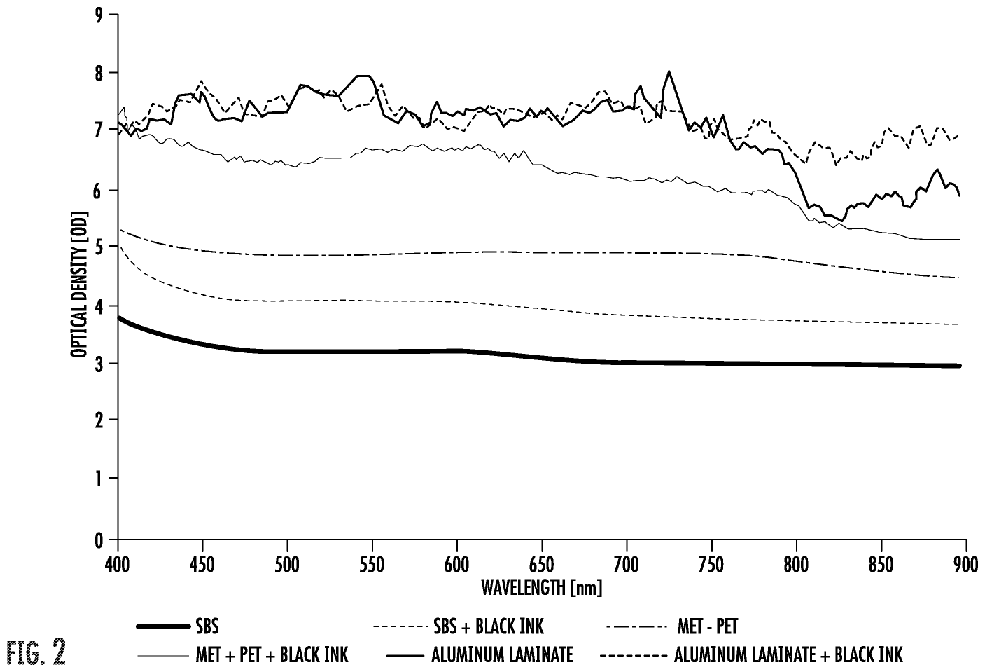

Using the test apparatus and protocol described below under the header Experimental Design, the light blocking capability of various materials of similar thickness was quantified. As shown in Table 1, SBS cardboard (14 point) achieves an attenuation of only Optical Density (OD) 3.2 over the spectral range from 400-900 nm, which permits an enormous photon flux to penetrate when considering that light exposure in typical storage locations such as a busy, well-lit pharmacy, is constant, and total light exposure is the integral of the entire time that the secondary packaging carton sits on the shelf, which could be weeks or months. And, as can be seen in FIG. 2, and based on Rayleigh scattering, NIR light penetrates secondary packaging materials better than visible light making it more difficult to block.

Given the relatively poor performance of SBS cardboard with respect to light blocking in general and NIR light in particular, the inventor recognized/identified a long-felt need for improved secondary packaging for optically sensitive pharmaceuticals. Despite the fact that light sensitive pharmaceuticals have been used for over 60 years, to date, these light sensitive pharmaceuticals are enclosed in secondary packaging of SBS cardboard alone, which only attenuates about 99.9% of incident visible and NIR light. The inventor recognized the deficiency and identified is a long-felt need to provide improved photostability for light sensitive pharmaceuticals. The inventor recognized that improved secondary packaging capable of providing light scattering and light absorption can be an efficient and cost-effective way to achieve this goal.

The inventor investigated several materials. The first was SBS cardboard (14 point) coated with black matte ink, but this resulted in only a 7-fold improvement in attenuation relative to SBS cardboard alone. As is known to those of skill in the art, the “point(s)” term (abbreviated by “pt.”) is used to refer to the thickness of a sheet of paper, including packaging corrugated paper. The thickness is measured using calipers, with each point representing 1/1000th of an inch.

Next, SBS coated with a thin layer of metallized (aluminum) polyester, known as MET-PET was tested. Typical MET-PET films are 5-20 μm in thickness, or approximately 1-10% of overall thickness depending on the overall thickness. MET-PET is a standard material in retail packaging, where it is used to block light and provide surfaces that range from highly-reflective to matte. SBS coated with reflective MET-PET with a total thickness of 14-pt only provided an additional 8-fold attenuation relative to SBS cardboard with blank matte ink (Table 1 and FIG. 2). However, SBS cardboard and MET-PET coated with an ultrathin layer of black matte ink (typically 5-20 μm), having a total thickness of 14-pt, further reduced light transmission and may be suitable for some uses.

TABLE 1
Table 1 - Transmission and Attenuation of
Light by Secondary Packaging Materials

| | | Attenuation |
|---|---|---|
| | | (Log Optical |
| Material | Transmission | Density) |
| None | 100% | 0.0 |
| SBS Cardboard (14 point) | 0.068817% | 3.2 |
| SBS Cardboard (14 point) + Black Matte Ink | 0.009659% | 4.0 |
| SBS + MET-PET (14 point) | 0.001262% | 4.9 |
| SBS + MET-PET (14 point) + Black Matte | 0.000048% | 6.3 |
| Ink | | |
| SBS + Aluminum Laminate (10 point) | 0.000008% | 7.1 |
| SBS + Aluminum Laminate (10 point) + | 0.000006% | 7.2 |
| Black Matte Ink | | |

As shown in FIG. 2 and Table 1, another material evaluated was an alternative paper technology called aluminum laminate, where an ultrathin sheet of solid aluminum foil (typically 5-20 μm) is laminated directly to one of the primary surfaces of the SBS cardboard (SBS+aluminum laminate) resulting in a total thickness of 10-pt. Although the aluminum foil is thin and is a very small fraction of the overall thickness of the packaging material (e.g., 1-10% depending on aluminum thickness and overall thickness, it unexpectedly and remarkably produced a very effective light blocking material. The SBS+aluminum laminate resulted in no detectable visible or NIR light being transmitted through the material, with measurements being at the noise level of the spectrometer. In fact, SBS with aluminum laminate covered in black matte ink, having a total thickness of 10-pt, was 4 logs, equivalent to 10,000-fold, better at attenuating light than SBS cardboard alone (Table 1 and FIG. 2). FIG. 2 shows the light transmission and spectral filtering of the materials listed in Table 1 from 400-900 nm.

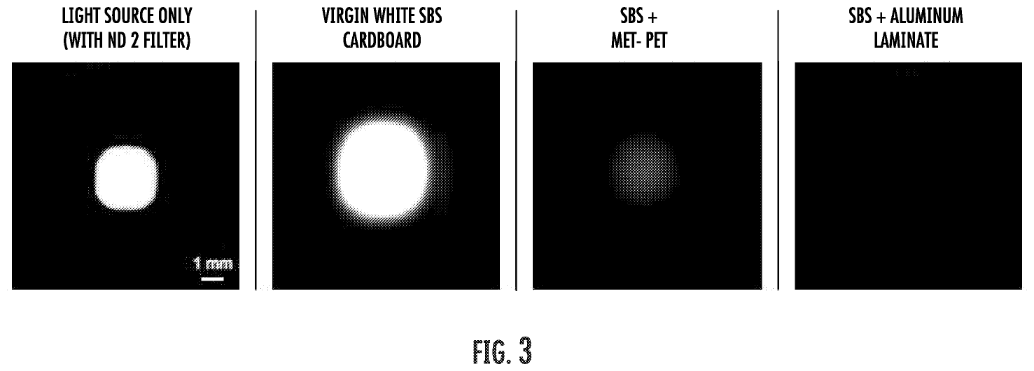

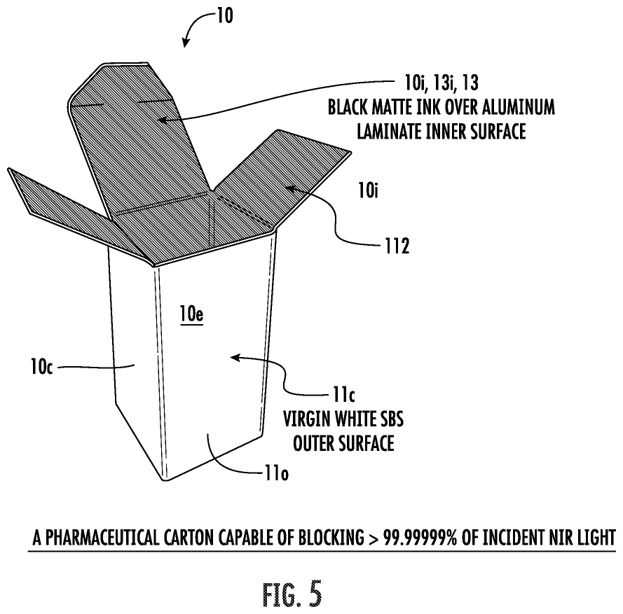

FIG. 3 illustrates that higher penetration of NIR light versus visible light is seen in all materials except SBS+aluminum laminate. A point source of light is attenuated and blurred when passing through SBS cardboard, with further attenuation by the addition of MET-PET. Full light blocking is only achieved with aluminum laminate. A 2-log neutral density (ND 2) filter was placed between the light source and camera in the “Light Source Only” image (left side) to prevent camera saturation. All images have identical exposure time (50 msec) and brightness, contrast, and gamma settings. Secondary packaging 10 with SBS cardboard and aluminum laminate can be configured so that NIR light can be totally or almost totally blocked (far right photograph). As shown in FIGS. 4 and 5, cardboard can be configured to define at least one primary surface, shown as the external surface 10e of the carton 10c and the black or black matte ink can form or define the inner surface 10i. The reverse configuration may be used. In some embodiments, the inner and outer primary surfaces of the cardboard carton 10c can comprise black or black matte ink over an aluminum laminate layer or layers or directly on the cardboard surfaces. FIG. 5 also shows the flaps 112 with the inner surface 10i comprising the black or black matte ink. The cardboard can be any suitable cardboard material and is not required to be SBS cardboard. For example, Clay Coated News Back (CCNB), Folding Box Board (FBB), and Natural Kraft (SUS) and Coated Unbleached Kraft (CUK), although each, alone, suffers from its NIR light transmission.

FIG. 4 is a schematic illustration of the secondary packaging 10 providing a rectangular carton 10c holding primary packaging 100 enclosing a pharmaceutical 200, which may be in fluid form. The primary packaging 100 can be provided as a sterile glass vial, which may be clear glass. The glass vial 100v can be in any suitable size, such as in a range of 4 ml to 500 ml, in some embodiments. Larger and smaller vials may be used. The secondary packaging 10 can enclose a folded product insert (informational) leaflet (“PIL”) 120, typically in folded form with a closed bottom and open top forming an open elongate space 120s whereby the vial 100 can be placed inside the open space 120s. The carton 10c can be rectangular with a height “h” greater than a width “w” as shown in FIG. 4. The carton 10c can have a height of 70 mm, a width and depth of 35 mm, in some particular embodiments. However, other shapes and sizes of cartons may be used.

The secondary packaging 10 can comprise three layers 11, 12, 13 of three different materials. The three layers 11, 12, 13, can be three laminated layers. The first layer 11 can be provided by the cardboard 11c, optionally SBS cardboard, and define a majority of the thickness of the secondary packaging 10 (typically 90-99% of the overall thickness). The cardboard 11c can be provided in a thickness range of 10-26 points. The overall packaging thickness can be in a range of 10-26 points. The cardboard 11c can have opposing outer and inner primary surfaces 11o, 11i. The outer primary surface 11o can define the outer or external surface 10e of the carton 10c (which may optionally be a virgin white SBS outer surface).

The second layer 12 can be a photon scatterer material and the third layer 13 can be a photon absorber material. The second layer 12 and the third layer 13 can be provided in the same thickness or different thicknesses provided that the total thickness of the package is in the desired thickness range, typically 10-26 pt.

The secondary packaging 10 can have an inner surface 10i defined by the third layer 13. The third layer 13 can comprise or include a black matte (pigment) ink 13i that provides the photon absorber material and can be printed, coated, rolled, or sprayed onto the second layer 12 of the photon scatterer, e.g., the MET-PET or the aluminum laminate. The term “black matte” is well known to those of skill in the art and refers to a pigment/ink that is highly absorbent of all wavelengths of light, e.g., all photons while eliminating surface reflections (scatter). The black matte layer can be applied separately using black ink followed by a transparent matte finish. In some embodiments, black ink can be used instead of black matte ink. In some embodiments, one or more layers of black ink can be used with one or more layers of translucent matte finish (e.g., varnish). When used in combination, the black ink with the translucent matte finish can define the inner surface or the outer surface, or both, of the packaging material 10/carton 10c.

The second layer 12 is preferably provided by the aluminum laminate discussed above. However, the second layer 12 may be provided by MET-PET instead, in some embodiments.

Examples of aluminum foil that can be used for the aluminum laminate layer can be found at www.alfipa.com/products/aluminum-foil-metallized-pet-film/. The MET-PET can have a similar thickness but because it's a mixture of plastic and metal has very low optical density. See, www.jindalpoly.com/products/met-pet. Black ink can be applied in a similar thickness (5-20 μm), typically depending on how many “passes” one makes to form the layer. See, www.zxprinter.com/support/ink-film-thickness.html. All three cited websites were accessed as of Nov. 19, 2021 and are incorporated by reference as if recited in full herein.

Also, if light manages to enter through the very small cracks in the carton folds, black matte pigment (ink) 13i applied (e.g., printed) onto the aluminum laminate surface 12 can be used to absorb the light leakage. Black matte ink is highly absorbent of all wavelengths of light while also eliminating surface reflections (i.e., scatter). Thus, a photon hitting a black matte surface is prevented from reflecting onto the pharmaceutical or drug in the primary packaging 100/vial 100v while simultaneously being absorbed (FIG. 4). Alternatively, black ink alone could be used if surface reflections are not considered high-risk. As shown in Table 1 and FIG. 2, SBS cardboard with aluminum laminate with black matte ink has almost the same excellent light attenuation properties as the SBS cardboard and aluminum laminate without the black matte ink/pigment, but with the black matte ink on the inner surface of the carton, the inside of the carton is maximally protected from reflected NIR light. The folded product insert leaflet (PIL) required by regulatory agencies to be included in the carton may add additional light protection to the vial, but PILs are often constrained to particular shapes and sizes and are not therefore a reliable method for light protection.

Notably, the secondary packaging 10 forming the pharmaceutical carton 10c is capable of blocking light with a transmission of about 0.000048% or less, such as about 0.000008% or 0.000006%. In some embodiments, the packaging material of the pharmaceutical carton 10c can block over 99.99%, over 99.999% or 99.99999% or more, of incident visible and NIR light. To put this level of performance in perspective, a pharmaceutical protected by the secondary packaging described in this application and exposed to light for 5 years will be exposed to the same amount of energy as a current conventional SBS carton when exposed to the same amount of light for only 4 hours and 28 minutes.

The inventor recognized a long-existing problem and identified a need for improved packaging of light sensitive pharmaceuticals that has been unrecognized in the field for over 60 years. The new carton 10c can provide significantly improved light blocking protection for optically active pharmaceuticals that have conventionally been provided in standard SBS cardboard secondary packaging for over 60 years. As more light-absorbing dyes and fluorophores enter clinical use, the new secondary packaging can provide improved photostability over conventional secondary packaging and addresses an important, unresolved problem.

The present invention is explained in greater detail in the following non-limiting Examples.

### EXAMPLES

Experimental Design: To acquire the data presented in Table 1 and FIG. 2, a Cary model 5000 scanning spectrometer was employed. An aperture was used to reduce the effect of scatter, and monochromatic light with a cone angle of F/7 was directed through the sample.

Summary: With respect to primary packaging, amber vials offer little benefit over clear vials in terms of NIR light attenuation and make particulate release testing much more difficult.

With respect to secondary packaging, the typical virgin white SBS cardboard used to manufacture pharmaceutical cartons is ineffective in blocking both visible and NIR light. The new material, composed of a multi-laminate of optical absorber and optical scatterer, provides the expected clean white exterior surface of a pharmaceutical carton, but is capable of blocking light energy that could otherwise degrade NIR fluorescent contrast agents.

To put the results in perspective, a drug vial stored in a carton of secondary packaging provided by embodiments of the present invention when exposed to light continuously for 5 years receives the same amount of energy as the same drug vial stored in a conventional SBS carton exposed to light for just 4 hours and 28 minutes.

The foregoing is illustrative of embodiments of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A pharmaceutical packaging material, comprising:
cardboard comprising opposing first and second primary surfaces, the first primary surface defining an external surface of the pharmaceutical packaging material, wherein the cardboard has a thickness in a range of 10-26 points;
a light scattering material attached to the first and/or second primary surface of the cardboard; and
a light absorbent material on the light scattering material.

2. The pharmaceutical packaging of claim 1, wherein the light scattering material and the light absorbent material have a cumulative thickness that is less than 10%, average, of the thickness of the cardboard.

3. The pharmaceutical packaging material of claim 1, wherein the pharmaceutical packaging material blocks incident visible and/or near-infrared (NIR) light at an attenuation of log 4 optical density or greater.

4. The pharmaceutical packaging material of claim 1, wherein the light scattering material is defined by aluminum laminate directly laminated or directly bonded to the first and/or the second primary surface of the cardboard.

5. The pharmaceutical packaging material of claim 1, wherein the light absorbent material comprises black ink covering the light scattering material.

6. The pharmaceutical packaging material of claim 1, wherein the light absorbent material comprises black matte ink covering the light scattering material.

7. The pharmaceutical packaging material of claim 1, wherein the pharmaceutical packaging material is provided as a carton.

8. The pharmaceutical packaging material of claim 1, wherein the cardboard comprises solid bleached sulphate (SBS) cardboard.

9. The pharmaceutical packaging of claim 7, in combination with a vial comprising a light-absorbing pharmaceutical held in the carton.

10. A pharmaceutical package comprising:
a vial of glass enclosing an optically active pharmaceutical; and
a carton holding the vial of glass, wherein the carton comprises a multi-laminate configuration of cardboard and one or more additional layers configured to block incident visible and/or near-infrared (NIR) light at an attenuation of log 4 optical density or more to thereby provide improved photostability for the optically active pharmaceutical in the vial relative to SBS cardboard alone.

11. The pharmaceutical package of claim 10, wherein the cardboard is in a thickness range of 10-26 points, and wherein the one or more additional layers is provided by one of the following: (i) aluminum laminate and black ink or black matte ink; (ii) MET-PET and black ink or black matte ink; (iii) only aluminate laminate; and (iv) only MET-PET.

12. The pharmaceutical package of claim 10, wherein the cardboard is SBS cardboard in a total thickness range of 10-26 points and defines a white external surface of the carton, and wherein the one or more additional layers comprises aluminum laminate.

13. The pharmaceutical package of claim 10, wherein the one or more additional layers comprises aluminum laminate, and wherein the pharmaceutical package further comprises black ink covering the aluminum laminate.

14. The pharmaceutical package of claim 13, wherein the black ink defines an inner surface of the carton.

15. The pharmaceutical package of claim 12, further comprising black matte ink covering the aluminum laminate and defining an inner surface and/or outer surface of the carton.

16. The pharmaceutical package of claim 10, wherein the multi-laminate configuration of the carton is configured to block about 99.99% or more of incident visible and NIR light.

17. The pharmaceutical package of claim 10, wherein the multi-laminate configuration of the carton is configured to block about 99.9999% or more of incident visible and NIR light.
